(19) United States
(12) Patent Application Publication
(10) Pub. No.: US 2009/0265917 A1
(43) Pub. Date: Oct. 29, 2009

(54) METHOD OF MANUFACTURING THIN FILM MAGNETIC HEAD

(75) Inventors: Koichi Sugimoto, Kawasaki (JP); Masanori Tachibana, Kawasaki-shi (JP); Kazuaki Satoh, Kawasaki (JP); Yoshiyuki Ikeda, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/333,206

(22) Filed: Dec. 11, 2008

(30) Foreign Application Priority Data
Apr. 28, 2008 (JP) 2008116665

(51) Int. Cl. G11B 5/187; G11B 5/255

(52) U.S. Cl. 29/603.13; 29/603.15; 29/603.16

(57) ABSTRACT

By the method of manufacturing a thin film magnetic head, a magnetic material having a suitable characteristic can be used for manufacturing a magnetic pole and corrosion of the magnetic pole can be prevented. The method comprises: a step of forming a multilayered magnetic pole; a step of forming a stopper layer on the magnetic pole; a step of forming an insulating layer on the stopper layer; a step of polishing the insulating layer, by chemical mechanical polishing process, until an upper face of the stopper layer is exposed; a step of removing the stopper layer, by dry etching process with a reactive gas, until an upper face of the magnetic head is exposed; a step of removing the upper face of the magnetic pole, by dry etching process with an inert gas, until reaching a prescribed depth; and a step of polishing the upper face of the magnetic pole, by chemical mechanical polishing process, until the upper face of the magnetic pole is flattened.

### BACKGROUND OF THE INVENTION

The present invention relates to a method of manufacturing a thin film magnetic head, more precisely relates to a method of manufacturing a thin film magnetic head having a recording magnetic head section, in which thin films are laminated on a substrate.

These days, memory capacities of storing units, e.g., magnetic disk unit, have been significantly increased. Thus, improving performance of storage media and improving reading and reproducing characteristics of magnetic heads are required. Magnetic heads including magnetoresistance effect (MR) elements, e.g., giant magnetoresistance (GMR) element capable of obtaining a high output power, tunneling magnetoresistance (TMR) element capable of obtaining high reproduction sensitivity, have been developed. On the other hand, induction type recording heads using electromagnetic induction have been developed. For example, a composite type thin film magnetic head, in which the above described reproducing head and recording head are combined, is now used.

In the recent magnetic disk unit, storage media are composed of a material having a greater coercive force so as to improve recording density. Thus, the recording head capable of generating a great magnetic field is required so as to write data in restricted narrower tracks. Therefore, a vertical recording type thin film magnetic head is used. Especially, a main magnetic pole of the recording head is composed of a magnetic material having high saturation magnetic flux density (high Bs).

Generally, the high Bs material has insufficient soft magnetic characteristics, and residual magnetization therein is great. Therefore, a problem of pole erase occurs. Namely, data recorded in the recording medium are erased by a magnetic field generated by the main magnetic pole despite no electric current passes through a write coil.

Thus, a thin film magnetic head, which is capable of solving the problem of pole erase caused by the residual magnetization of the main magnetic pole and whose main magnetic pole is composed of a magnetic material having high Bs, is disclosed in Japanese Laid-open Patent Publication No. 2007-311013. The thin film magnetic head is shown in FIG. 8.

A main magnetic pole 120 is constituted by two magnetic layers 121 and 122, which are laminated in the thickness direction. The upper magnetic layer 121 is a high Bs layer having a first Bs value; the lower magnetic layer 122 is a low Bs layer having a second Bs value which is less than the first Bs value.

In the Japanese Laid-open Patent Publication No. 2007-311013, the main magnetic has the multilayer structure, in which two or more magnetic layers are laminated in the thickness direction of the main magnetic pole, an upper or upmost layer is the high Bs layer, and a lower layer or layers are the low Bs layer or layers. This structure is capable of suitably improving characteristics. For example, the high Bs layer is composed of FeCo (iron-cobalt); the low Bs layer or layers are composed of NiFe (nickel-iron).

However, in a production process of a thin film magnetic head which includes a main magnetic pole having a single layer structure composed of a cobalt containing alloy or a multilayer structure, whose upmost layer is composed of a cobalt containing alloy, a first chemical mechanical polishing (CMP) process is performed, and then a second CMP process is performed. If a stopper layer, e.g., a tantalum layer, for the first CMP process is removed, by dry etching process, e.g., reactive ion etching (RIE), with a reactive gas, after performing the first CMP process, an upper face of the upmost layer of the main magnetic pole will be corroded after performing the second CMP process. This problem is a new problem not occurred in a conventional thin film magnetic head including a main magnetic pole having a single layer structure composed of NiFe or a multilayer structure, whose upmost layer is composed of NiFe.

### SUMMARY OF THE INVENTION

The present invention was conceived to solve the above described problem.

An object of the present invention is to provide a suitable method of manufacturing a thin film magnetic head, in which a magnetic material having a suitable characteristic can be used for manufacturing a magnetic pole, corrosion of the magnetic pole and manufacturing bad products can be prevented.

To achieve the object, the present invention has following constitutions.

Namely, a method of manufacturing a thin film magnetic head of the present invention comprises: a step of forming a magnetic pole for recording data, wherein thin films are laminated on a substrate; a step of forming a stopper layer on the magnetic pole; a step of forming an insulating layer on the stopper layer; a step of polishing the insulating layer, by chemical mechanical polishing process, until an upper face of the stopper layer is exposed; a step of removing the stopper layer, by dry etching process with a reactive gas, until an upper face of the magnetic head is exposed; a step of removing the upper face of the magnetic pole, by dry etching process with an inert gas, until reaching a prescribed depth; and a step of polishing the upper face of the magnetic pole, by chemical mechanical polishing process, until the upper face of the magnetic pole is flattened.

In the method, the magnetic pole may have a single layer structure composed of a cobalt containing alloy or a multilayer structure, whose upmost layer is composed of a cobalt containing alloy.

In the method, the reactive gas may be a fluorine reactive gas or a mixed gas of a fluorine reactive gas and an argon gas.

In the method, the inert gas may be an argon gas or a mixed gas of an argon gas and other inert gas or gasses.

In the method, the magnetic pole and terminal sections for mutually electrically connecting the layers of the thin film magnetic head may be simultaneously formed in the step of forming the magnetic pole.

In the method, the stopper layer may be composed of tantalum. Further, the dry etching process with the reactive gas and the dry etching process with the inert gas may be performed in a reactive ion etching apparatus.

In the method of the present invention, the upmost magnetic layer of the magnetic pole of the thin film magnetic head can be composed of a high Bs material, and the problem of corroding the magnetic layer can be solved. Therefore, characteristics of the thin film magnetic head can be improved, and manufacturing bad products can be prevented.

### BRIEF DESCRIPTION OF THE DRAWINGS

Embodiments of the present invention will now be described by way of examples and with reference to the accompanying drawings, in which:

FIG. 1 is a schematic sectional view of an example of a thin film magnetic head produced by the method of the present invention;

FIGS. 2A-2D are explanation views showing steps of a method of manufacturing the thin film magnetic head as an embodiment of the present invention;

FIGS. 3A-3D are explanation views showing further steps of the method;

FIGS. 4A and 4B are explanation views showing further steps of the method;

FIG. 5 is an explanation view showing a conventional method of manufacturing a thin film magnetic head;

FIG. 6 is a schematic plan view of the thin film magnetic head in process of production;

FIG. 7 is a graph showing a relationship between time period of performing dry etching with an argon (Ar) gas and production rate of good products; and

FIG. 8 is a schematic view of the main magnetic pole of the conventional thin film magnetic head.

### DETAILED DESCRIPTION OF THE EMBODIMENTS

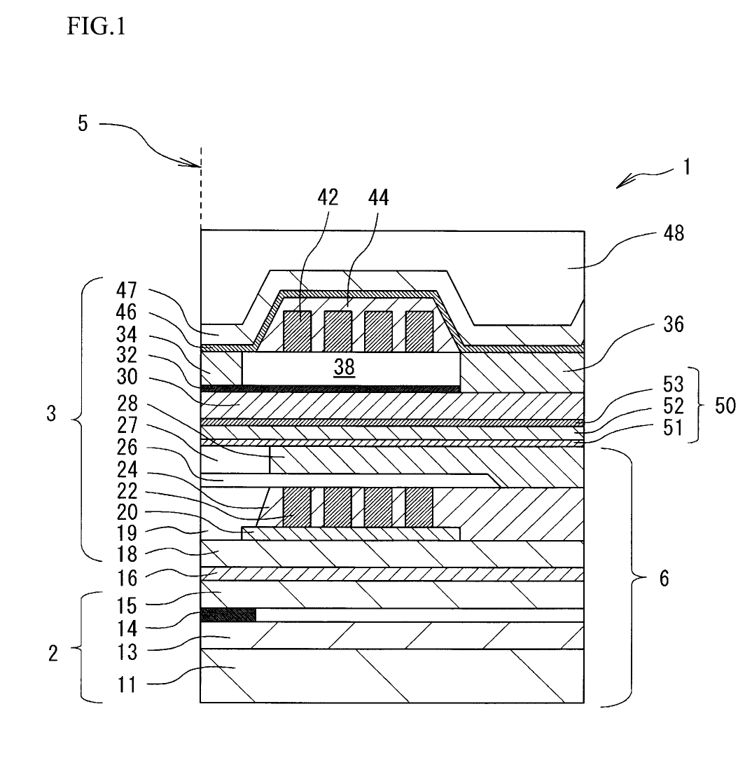

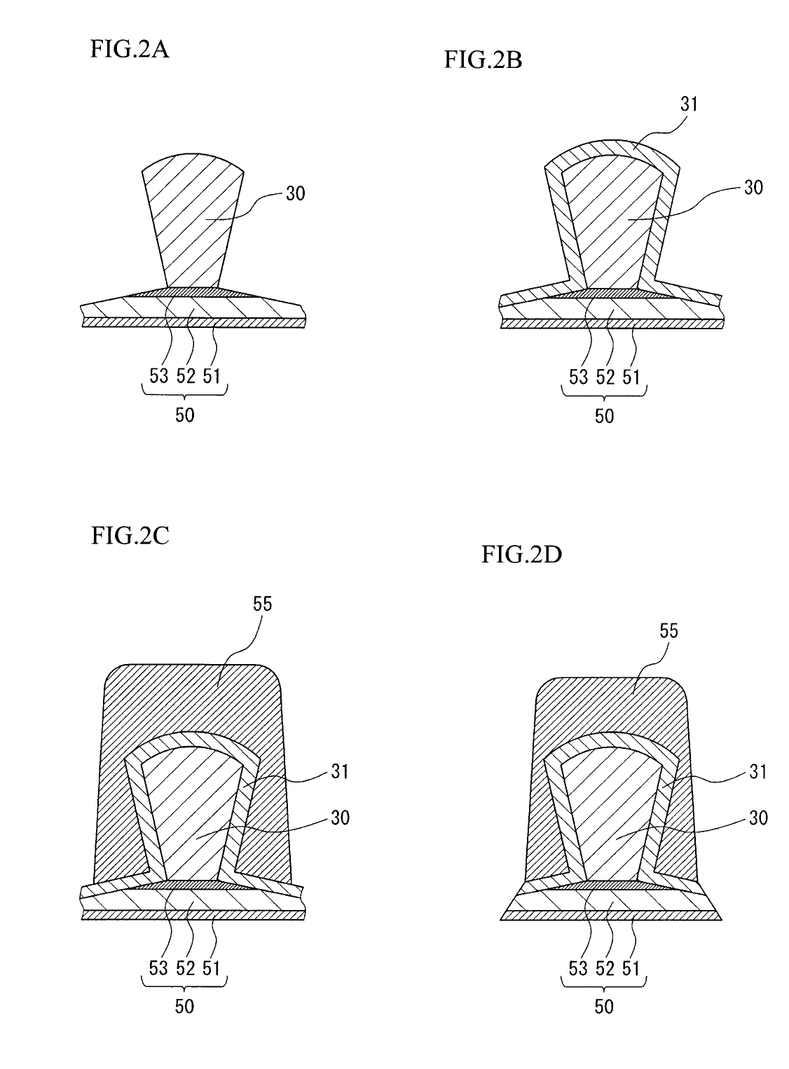

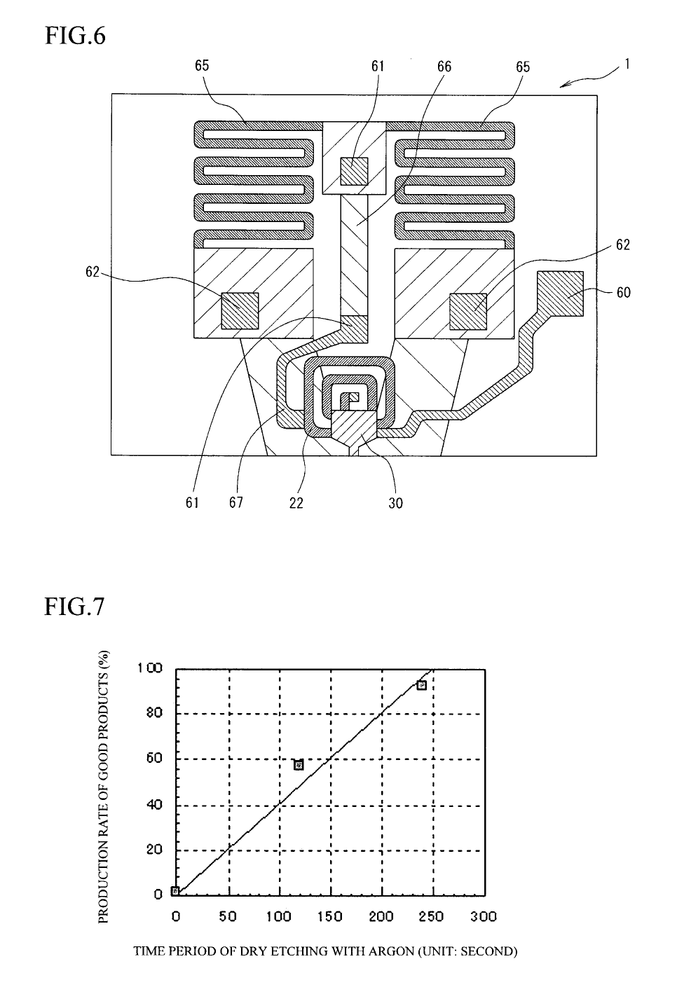

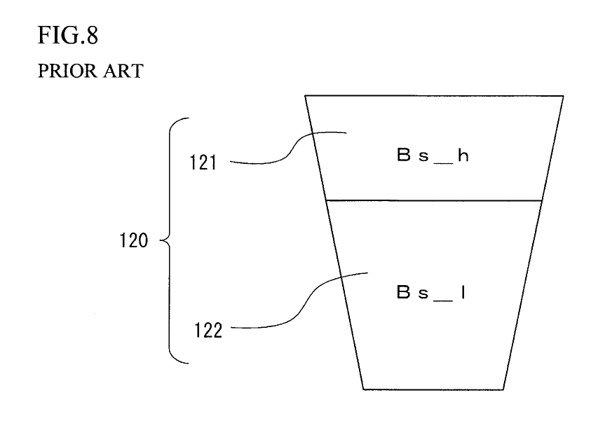

Preferred embodiments of the present invention will now be described in detail with reference to the accompanying drawings, in which: FIG. 1 is a schematic sectional view of an example of a thin film magnetic head 1, in the height direction thereof, produced by the method of the present invention; FIGS. 2A-4B are explanation views showing steps of a method of manufacturing the thin film magnetic head 1; FIG. 5 is an explanation view showing a conventional method of manufacturing a thin film magnetic head; FIG. 6 is a schematic plan view of the thin film magnetic head in process of production; FIG. 7 is a graph showing a relationship between time period of performing dry etching with an argon (Ar) gas and production rate of good products. FIG. 8 is a schematic view of an end face of the main magnetic pole of the conventional thin film magnetic head, which is seen from an air bearing surface side, note that a main magnetic pole 30 of the thin film magnetic head 1 of the present embodiment has the similar structure.

The thin film magnetic head 1 of the present embodiment has a recording head section 3, which writes magnetic signals, as data, in a storage medium, e.g., hard disk.

The recording head section 3 is formed by laminating films, and an air bearing surface 5 is formed perpendicular to surfaces of the laminated films. The structure having the air bearing surface 5 is called a head slider. By rotating the hard disk, the head slider is floated, by the air bearing surface 5, from a surface of the hard disk and capable of writing data in the hard disk.

The structure of the thin film magnetic head 1 will be explained. Note that, a vertical recording type thin film magnetic head will be explained as an example, but the present invention is not limited to the example.

As shown in FIG. 1, the thin film magnetic head 1 is a combined type thin film magnetic head, which includes a reproducing head section 2 and the recording head section 3. Note that, the present invention is not limited to the combined type thin film magnetic head.

In fact, the air bearing surface 5 will be formed, by a polishing process, after completing a laminating process (described later), so the reference symbol 5 in FIG. 1 indicates a predetermined place of the air bearing surface to be formed.

The reproducing head section 2 has a multilayered structure, in which a lower shielding layer 13, a magnetoresistance effect element 14 and an upper shielding layer 15 are laminated on a substrate 11. For example, the substrate 11 is composed of an insulating material, e.g., Al₂O₃-TiC.

The magnetoresistance effect element 14 is, for example, a TMR element or a GMR element. A film structure of the TMR element or the GMR element is not limited. Various types of film structures can be employed.

The lower shielding layer 13 and the upper shielding layer 15 are composed of a magnetic material (soft magnetic material), e.g., NiFe.

In the present embodiment, a magnetization separating layer 16, which is composed of an insulating material, is formed on the upper shielding layer 15. Further, the recording head section 3 is formed on the magnetization separating layer 16.

The recording head section 3 has a lower return yoke 18, which is composed of a magnetic material, e.g., NiFe. A first insulating layer 20 is formed on the lower return yoke 18. The first insulating layer 20 is composed of an insulating material, e.g., Al₂O₃. A reference symbol 19 stands for a second insulating layer composed of an insulating material, e.g., Al₂O₃.

Note that, a DFH (Dynamic Flying Height Control) heater (not shown), which is used to actually control projection of the recording head section 3 toward the air bearing surface 5, may be provided in the first insulating layer 20.

A lower coil 22, which is a planar spiral coil composed of an electrically conductive material, e.g., copper, is formed on the first insulating layer 20.

A third insulating layer 24 is formed in a spiral space defined by the lower coil 22. The second insulating layer 24 is composed of an insulating material, e.g., Al₂O₃.

A supplemental magnetic pole 28 is formed on the lower coil 22 and the third insulating layer 24, and a fourth insulating layer 26 is partially provided therebetween. The supplemental magnetic pole 28 is composed of a magnetic material, e.g., NiFe, and the fourth insulating layer 26 is composed of an insulating material, e.g., Al₂O₃. A reference symbol 27 stands for a fifth insulating layer 27 composed of an insulating material, e.g., Al₂O₃.

In the present embodiment, a base body 6 is constituted by the substrate 11 and the laminated layers from the fifth insulating layer 27 to the supplemental magnetic pole 28.

Note that, the layered structure of the base body 6 is not limited to the above described structure. Various layered structures may be employed.

A plated base 50 and the main magnetic pole 30 are formed on the base body 6. For example, the main magnetic pole 30 has the multilayer structure, in which two magnetic layers are laminated in the thickness direction as well as the conventional example shown in FIG. 8. An upper magnetic layer of the two is a high Bs magnetic layer having a first Bs value; a lower magnetic layer of the two is a low Bs magnetic layer having a second Bs value which is less than the first Bs value. In the present embodiment, the high Bs magnetic layer (the upper layer) is composed of a high Bs material (a cobalt containing alloy), e.g., FeCo (for example, 69.5% FeCo); the low Bs magnetic layer (the lower layer) is composed of a low Bs material, e.g., NiFe (for example, 90% NiFe). With this structure, the problem of pole erase, which is caused by residual magnetization of the main magnetic pole 30, can be solved, so that high density recording can be realized.

Note that, the layered structure of the main magnetic pole 30 is not limited to the two-layer structure. The main magnetic pole 30 may have a singly layer structure, which is composed of the high Bs material (the cobalt containing alloy), or a multilayer structure having three or more layers, in which the upmost layer is composed of the high Bs material (the cobalt containing alloy).

The plated base 50 has a three-layer structure, in which a tantalum (Ta) layer 51, a ruthenium (Ru) layer 52 and a NiFe layer 53 are laminated in this order.

A trailing gap 32 and a connecting portion 36 are formed on the main magnetic pole 30, and a trailing shield 34 is formed on a part of the trailing gap 32. The trailing gap 32 is composed of an insulating material, e.g., Al₂O₃, and the trailing shield 34 and the connecting portion 36 is composed of a magnetic material, e.g., NiFe.

Note that, a sixth insulating layer 38, which is composed of an insulating material, e.g., Al₂O₃, is formed around the trailing shield 34 and the connecting portion 36. In the present embodiment, upper faces of the trailing shield 34, the connecting portion 36 and the sixth insulating layer 38 are flattened and level with each other in this process stage.

Further, an upper coil 42, which is a planar spiral coil composed of an electrically conductive material, e.g., copper, is formed on the sixth insulating layer 38.

A seventh insulating layer 44 is formed in a spiral space defined by the upper coil 42 and on the upper coil 42. The seventh insulating layer 44 is composed of an insulating material, e.g., resist.

An upper return yoke 47 is formed on the seventh insulating layer 44. The upper return yoke 47 is composed of a magnetic material, e.g., NiFe.

Further, an eighth insulating layer 48, which is composed of an insulating material, e.g., Al₂O₃, is formed on the upper return yoke 47.

Successively, a method of manufacturing the thin film magnetic head 1 of the present embodiment will be explained.

In the method of the present embodiment, the magnetization separating layer 16 is formed after forming the reproducing head section 2, and then the recording head section 3 is formed on the magnetization separating layer 16. Firstly, characterized steps of the method will be explained.

The base body 6, which is constituted by the fifth insulating layer 27, the supplemental magnetic pole 28, etc., is firstly formed, and then the upper face of the base body 6 is entirely flattened by, for example, a lapping machine. Further, the plated base 50 and the main magnetic pole 30 are formed on the flattened face of the base body 6. A sectional view of an air bearing surface side end of the main magnetic pole 30 is shown in FIG. 2A, in which the base body 6 is not shown.

The main magnetic pole 30 is formed by an electroplating process, in which a mask (not shown) composed of resist is used. As described above, the plated base 50 is formed by laminating the Ta layer 51, the Ru layer 52 and the NiFe layer 53 in this order.

Next, a Ta layer 31, which acts as a stopper layer for a first CMP process to be performed in the following step, is formed on the main magnetic pole 30 and the plated base 50 by sputtering (see FIG. 2B).

Next, a resist layer 55 is formed on a protection area, e.g., around the main magnetic pole 30, so as to protect the protection area from a dry etching process to be performed in the following step (see FIG. 2C).

Next, as shown in FIG. 2D, the dry etching, e.g., ion milling, is performed to remove unwanted parts of the plated base 50.

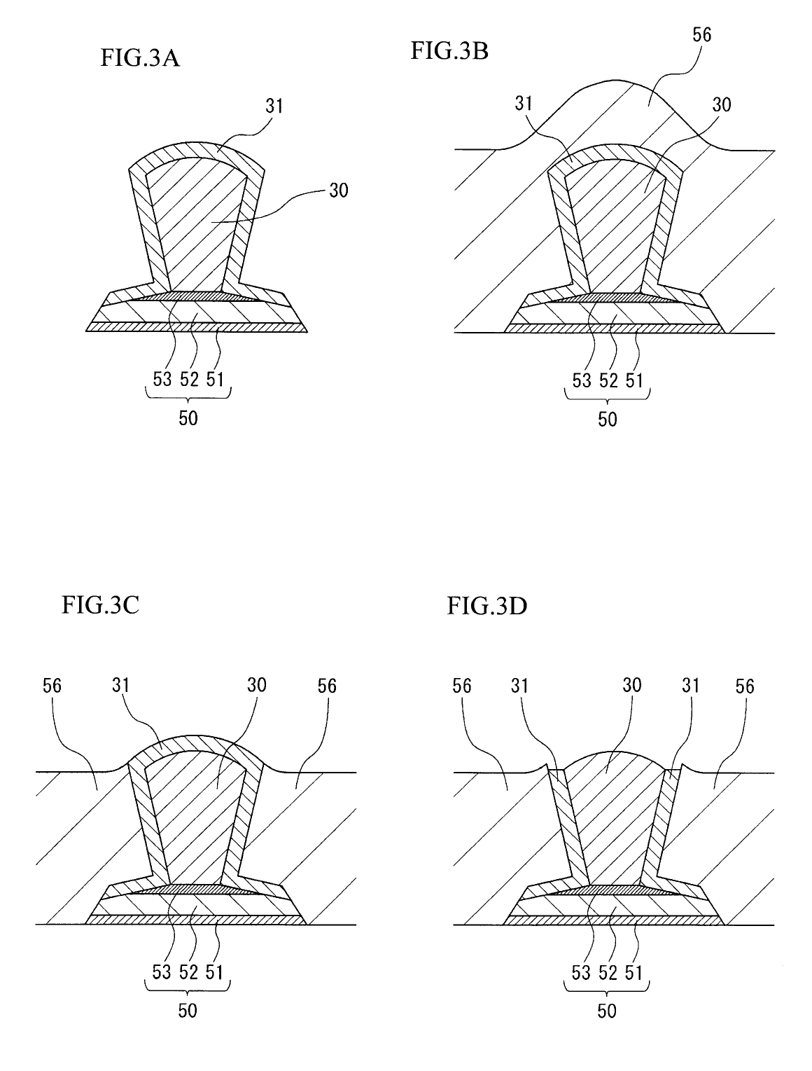

Next, as shown in FIG. 3A, the resist layer 55 is removed.

Next, as shown in FIG. 3B, a ninth insulating layer 56, which is composed of an insulating material, e.g., Al₂O₃, is formed to coat the stopper layer 31.

Next, as shown in FIG. 3C, the first CMP process is performed so as to polish the ninth insulating layer 56 until an upper face of the stopper layer 31 is exposed. In this step, Ta constituting the stopper layer 31 is hardly abraded by the first CMP process.

Further, as shown in FIG. 3D, the stopper layer 31 is removed, by a dry etching process with a reactive gas, e.g., RIE, until an upper face of the main magnetic pole 30 is exposed. Note that, the dry etching process may be performed with inductively coupled plasma (ICP) instead of RIE.

In this step, the reactive gas is a fluorine reactive gas or a mixed gas of a fluorine reactive gas and an argon (Ar) gas. For example, CF₄, C₂F₆, SF₆, etc. may be employed as the fluorine reactive gas.

In the present embodiment, a mixed gas of CF₄ and Ar is used as the reactive gas. In case that only CF₄ is used as the reactive gas, a rate of etching the stopper layer 31 composed of Ta is increased, so it is difficult to control the dry etching process. On the other hand, by using the mixed gas as the reactive gas, the dry etching process can be suitably controlled. If the etching rate is too high, the Ta layer 31, which acts as side shield gaps on the both sides of the main magnetic pole 30, will be damaged, and an abnormal configuration will be formed. Thus, the dry etching process is suitably performed, with the mixed gas, at a low etching rate.

In the conventional method of manufacturing a thin film magnetic head, as shown in FIG. 5, the upper face of the main magnetic pole 30 is polished, by a second CMP process, until the upper face is flattened.

However, in the conventional method, the surface of the upmost magnetic layer (FeCo layer) is corroded as described above. The inventors think that fluorine (F) of the reactive gas invades into the surface of the upmost magnetic layer (FeCo layer), and the fluorine in the surface reacts with water and slurry when the second CMP process is performed so that the corrosion occurs. Note that, in another conventional method wherein the upmost magnetic layer is composed of NiFe, no corrosion occurs.

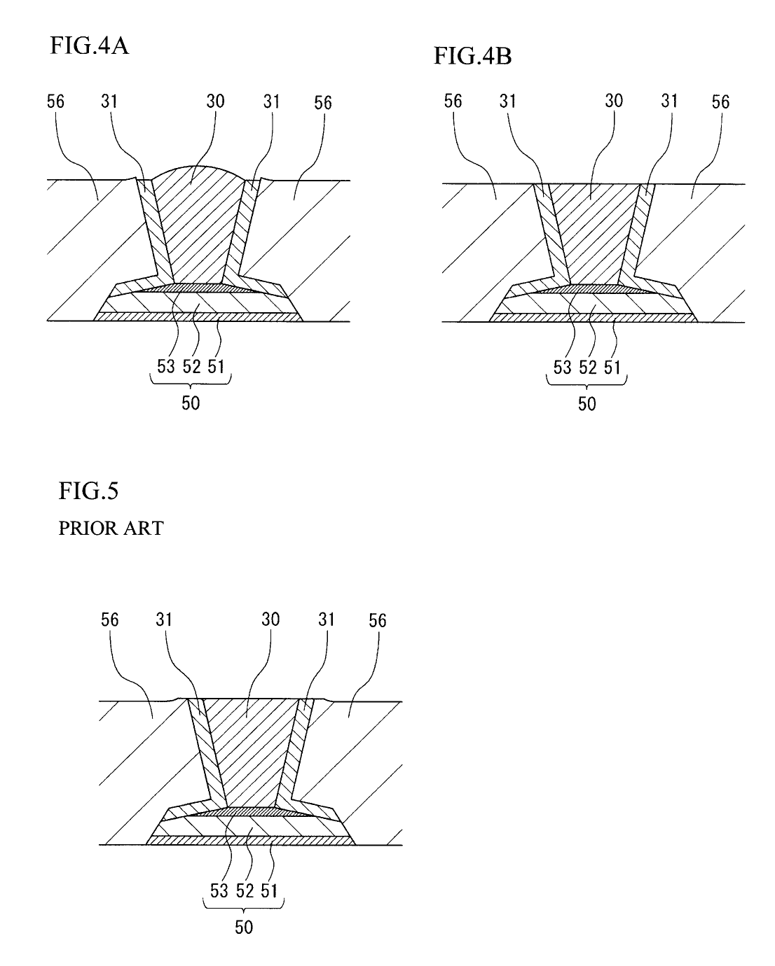

In the production method of the present embodiment, the upper face of the main magnetic pole 30 is exposed by the dry etching process with the reactive gas as shown in FIG. 3D. Further, as shown in FIG. 4A, the upper face of the upmost magnetic layer (FeCo layer) of the magnetic pole 30 is etched, by another dry etching process with an inert gas, until reaching a prescribed depth. The prescribed depth is equal to a depth of the fluorine invasion, which occurs in the former dry etching process. The prescribed depth is defined according to dry etching conditions. In the present embodiment, the prescribed depth is about 15 nm.

In the present embodiment, the Ar gas is used as the inert gas, but a mixed gas of the Ar gas and other inert gas or gasses may be employed as the inert gas for the second dry etching process.

By performing the second dry etching process, the part of the upper face of the upmost magnetic layer (FeCo layer) of the magnetic pole 30, which includes the fluorine, can be removed.

Therefore, the corrosion of the upmost layer of the main magnetic pole 30 can be prevented, and process failure and manufacturing bad products, which are caused by the corrosion, can be prevented.

As described above, the mixed gas of the fluorine reactive gas and the Ar gas is used, as the reactive gas, in the first dry etching process shown in FIG. 3D, and the Ar gas is used, as the inert gas, in the second dry etching process shown in FIG. 4A. The two dry etching processes can be performed in one RIE apparatus. The Ar gas is the common gas in the both dry etching processes, so the first dry etching process and the second dry etching process can be switched by selectively supplying the Ar gas and stopping the supply of the Ar gas.

With this structure, the two dry etching processes can be performed in the same apparatus, so that some production steps, e.g., a step of transferring a work piece, can be omitted, the production process can be highly simplified and a takt time can be shortened.

Note that, the first dry etching process shown in FIG. 3D may be performed in the RIE apparatus, and the second dry etching process shown in FIG. 4A may be separately performed in an ion milling apparatus.

After performing the step shown in FIG. 4A, the upper face of the main magnetic pole 30 is polished, by a second CMP process, until the upper face is flattened (see FIG. 4B).

Further, a publicly known step of forming prescribed layers on the main magnetic pole 30 (not shown) is performed, so that the thin film magnetic head 1 shown in FIG. 1 is completely produced.

The present invention is further characterized in that the main magnetic pole 30 and terminal sections for mutually electrically connecting the layers of the thin film magnetic head 1 are simultaneously formed in the step of forming the magnetic pole 30.

An example of the terminal section is a terminal section 60 of a DFH heater (see FIG. 6). Note that, FIG. 6 is a schematic plan view of the thin film magnetic head 1 in process of production, wherein the step shown in FIG. 4B has been finished.

The problem of the corrosion frequently occurs in the terminal sections, which are formed in the step of forming the main magnetic pole 30. By simultaneously forming the main magnetic pole 30 and the terminal sections, the problem of the corrosion can be solved, so that process failure and manufacturing bad products can be prevented.

Finally, a graph of a relationship between time period of performing the dry etching process with the argon (Ar) gas (see FIG. 4A) and production rate of good products is shown in FIG. 7. Effectiveness of the production method of the present invention will be explained with reference to FIG. 7.

As shown in FIG. 7, in case of performing no dry etching with the Ar gas, the production rate of good products, i.e., thin film magnetic heads, is 1.5%. Namely, most products are bad products, in each of which the corrosion occurs. On the other hand, in case of performing said dry etching for 120 seconds, the production rate of good products is 57.3%. Further, in case of performing said dry etching for 240 seconds, the production rate of good products is 92.6%.

According to FIG. 7, the dry etching process with the inert gas is capable of preventing the corrosion, so that the process failure and manufacturing bad products, which are caused by the corrosion, can be highly effectively prevented. Note that, in the present embodiment, the production rate of good products of 100% can be obtained by performing the dry etching process for 250 seconds or more.

As described above, in the method of manufacturing the thin film magnetic head of the present embodiment, the upmost magnetic layer of the main magnetic pole is composed of the high Bs cobalt containing alloy, so that the problem of pole erase can be solved and the thin film magnetic head can record data with higher density. Further, the process failure and manufacturing bad products, which are caused by the corrosion, can be highly effectively prevented.

Note that, in the above described embodiment, the thin film magnetic head is the vertical recording type thin film magnetic head, but the present invention is not limited to the vertical recording type thin film magnetic head.

The invention may be embodied in other specific forms without departing from the spirit of essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. A method of manufacturing a thin film magnetic head, comprising:
a step of forming a magnetic pole for recording data, wherein thin films are laminated on a substrate;
a step of forming a stopper layer on the magnetic pole;
a step of forming an insulating layer on the stopper layer;
a step of polishing the insulating layer, by chemical mechanical polishing process, until an upper face of the stopper layer is exposed;
a step of removing the stopper layer, by dry etching process with a reactive gas, until an upper face of the magnetic head is exposed;
a step of removing the upper face of the magnetic pole, by dry etching process with an inert gas, until reaching a prescribed depth; and
a step of polishing the upper face of the magnetic pole, by chemical mechanical polishing process, until the upper face of the magnetic pole is flattened.

2. The method according to claim 1,
wherein the magnetic pole has a single layer structure composed of a cobalt containing alloy or a multilayer structure, whose upmost layer is composed of a cobalt containing alloy.

3. The method according to claim 1,
wherein the reactive gas is a fluorine reactive gas or a mixed gas of a fluorine reactive gas and an argon gas.

4. The method according to claim 2,
wherein the reactive gas is a fluorine reactive gas or a mixed gas of a fluorine reactive gas and an argon gas.

5. The method according to claim 1,
wherein the inert gas is an argon gas or a mixed gas of an argon gas and other inert gas or gasses.

6. The method according to claim 2,
wherein the inert gas is an argon gas or a mixed gas of an argon gas and other inert gas or gasses.

7. The method according to claim 3,
wherein the inert gas is an argon gas or a mixed gas of an argon gas and other inert gas or gasses.

8. The method according to claim 4,
wherein the inert gas is an argon gas or a mixed gas of an argon gas and other inert gas or gasses.

9. The method according to claim 1,
wherein the magnetic pole and terminal sections for mutually electrically connecting the layers of the thin film magnetic head are simultaneously formed in said step of forming the magnetic pole.

10. The method according to claim 2,
wherein the magnetic pole and terminal sections for mutually electrically connecting the layers of the thin film magnetic head are simultaneously formed in said step of forming the magnetic pole.

11. The method according to claim 3,
wherein the magnetic pole and terminal sections for mutually electrically connecting the layers of the thin film magnetic head are simultaneously formed in said step of forming the magnetic pole.

12. The method according to claim 4,
wherein the magnetic pole and terminal sections for mutually electrically connecting the layers of the thin film magnetic head are simultaneously formed in said step of forming the magnetic pole.

13. The method according to claim 5,
wherein the magnetic pole and terminal sections for mutually electrically connecting the layers of the thin film magnetic head are simultaneously formed in said step of forming the magnetic pole.

14. The method according to claim 6,
wherein the magnetic pole and terminal sections for mutually electrically connecting the layers of the thin film magnetic head are simultaneously formed in said step of forming the magnetic pole.

15. The method according to claim 7,
wherein the magnetic pole and terminal sections for mutually electrically connecting the layers of the thin film magnetic head are simultaneously formed in said step of forming the magnetic pole.

16. The method according to claim 8,
wherein the magnetic pole and terminal sections for mutually electrically connecting the layers of the thin film magnetic head are simultaneously formed in said step of forming the magnetic pole.

17. A method of manufacturing a thin film magnetic head,
comprising:
a step of forming a magnetic pole for recording data, in which thin films are laminated on a substrate and at least an upmost layer is composed of a cobalt containing alloy;
a step of forming a stopper layer composed of tantalum on the magnetic pole;
a step of forming an insulating layer on the stopper layer;
a step of polishing the insulating layer, by chemical mechanical polishing process, until an upper face of the stopper layer is exposed;
a step of removing the stopper layer, by dry etching process with a mixed gas of a fluorine reactive gas and an argon gas, until an upper face of the magnetic head is exposed, and then removing the upper face of the magnetic pole, by dry etching process with an argon gas, until reaching a prescribed depth, wherein the dry etching processes are performed in a reactive ion etching apparatus; and
a step of polishing the upper face of the magnetic pole, by chemical mechanical polishing process, until the upper face of the magnetic pole is flattened.
